(19) United States
(12) Patent Application Publication
(10) Pub. No.: US 2020/0402183 A1
(43) Pub. Date: Dec. 24, 2020

(54) REAL ESTATE SERVICES COMMUNICATION SYSTEM

(71) Applicants: ALexandria Middleton, Haymarket, VA (US); Lesley Salman, Haymarket, VA (US)

(72) Inventors: ALexandria Middleton, Haymarket, VA (US); Lesley Salman, Haymarket, VA (US)

(21) Appl. No.: 16/907,200

(22) Filed: Jun. 20, 2020

Related U.S. Application Data
(60) Provisional application No. 62/865,208, filed on Jun. 22, 2019.

(51) Int. Cl. G06Q 50/00; G06Q 50/16; G06Q 10/06; G06Q 50/26; G06Q 30/00; G06Q 40/02; G06Q 10/10; G06Q 20/10; G06Q 30/02; G06F 9/445; H04L 29/08; G01S 19/01

(52) U.S. Cl. CPC G06Q 50/01; G06Q 50/16; G06Q 10/06311; G06Q 50/265; G06Q 30/0185; G01S 19/01; G06Q 10/1097; G06Q 20/108; G06Q 30/0282; G06F 9/445; H04L 67/34; G06Q 40/025

(57) ABSTRACT

A real estate services communication system and method for improving the efficiency of real estate home showings. The real estate communication system is typically comprised of at least one seller agent device, at least one showing agent(s) devices, and application software. When a selling agent receives a buyer request to be shown a property, the selling agent can send out the request to show the property to a selected showing agent in the selling agent's network, who can then show the buyer the property. This system provides the selling agent a more efficient way to show properties, the buyers more conveniently arranged showings, and the showing agent a convenient source of extra income.

### CROSS REFERENCE TO RELATED APPLICATION(S)

This application claims the benefit of, U.S. Provisional Patent Application No. 62/865,208 entitled “REAL ESTATE SERVICES COMMUNICATION SYSTEM,” filed on 22 Jun. 2019. The subject matter of this application is hereby incorporated by reference in its entirety.

### TECHNICAL FIELD OF THE INVENTION

The present invention relates to the general art of real estate and more specifically to an apparatus and method for improved communication and interaction among agents and buyers.

### BACKGROUND OF THE INVENTION

In recent decades, there have been a number of changes in the real estate field. Several of these changes relate to population density, geographic size of markets, and the working hours, geographic house-hunting range, and expectations of home buyers. In the past, showing homes to potential buyers was simpler for a typical real estate agent because a number of factors limited the time windows and geographic range such an agent was expected to cover.

A real estate agent tended to work in a smaller town, or a portion of a city, limiting the size of their territory. Most home buyers worked similar daytime hours during a work week and had a fairly uniform time window for when they would want to look at homes to potentially buy. Further, home buyers had access to a local newspaper or real estate publication, limiting the area of search. All these factors meant that it was relatively easier for an agent to schedule home showings in a limited time window (often early evenings or weekends) and in a nearby area.

However, these factors have all changed, particularly in the past decade. This has added to the complexity and difficulty of showing homes. Though many people still do work typical day-time hours, many do not, or work at home so they have more control of their schedule. Further, with the advent of internet listings, a buyer's search area has greatly expanded. This is occurring while urban areas are becoming larger and more sprawling, which can moving from one location to another more difficult. All of this means that a realtor is likely to be expected to show homes over a much larger area that is more difficult to travel around, and at more irregular times. This has created a number of scheduling challenges that thus far, have not been adequately addressed.

An agent with such challenges is often forced to involve other agents to timely show buyers homes. This often results in a situation wherein the agent has to split commission with the showing agent, losing up to half their payment for doing far more than half of the work. If a agent cannot be found to meet buyer's needs in time, the buyer may lose out on a wanted property, or may lose interest, or find another agent, resulting in total loss of commission. The consequences of this issue include loss of commission, loss of a property a buyer wants.

### SUMMARY

A real estate services communication system and method for improving the efficiency of real estate home showings is provided. The real estate communication system is typically comprised of at least a central server, at least one seller agent communication device, at least one showing agent(s) devices, and application software.

Generally, the system has a set-up and networking phase, and an operational phase. In a preferred embodiment, created application software for operating the system is loaded into a central server.

Application software capable of operating on the central server, and which can be modified for other parties and devices, is further loaded into at least one selling agent's communication device.

Next, one or more showing agents using suitable electronic devices interested in receiving showing opportunities can obtain application software, by downloading it onto their respective device(s). The application software can be loaded onto the showing agent communication devices by any suitable method in the art. For example, the selling agent may obtain the software from an “App store” site on the smartphone, from a website, or receive software directly from the selling agent communication device.

Next, the respective showing agent(s) enter the selling agent's network of showing agents. In one embodiment, the showing agent(s) is required to provide suitable Identification and proof of being an agent in good standing, such as a real estate license number and other personal identifying information, such as name, age, and address.

This information is transmitted from the showing agent(s) device(s) to the central server and/or to the selling agent's device. In another embodiment, the showing agent(s) devices include Global Positioning Satellite (GPS) location technology, and the system can be programmed to access GPS information on the showing agent(s) device(s).

Next, the showing agent(s) applicant is evaluated and either accepted or not accepted into the network. Here, the software can be programmed to run and confirm a check of the information provided by a potential showing agent. Further, potential showing agent(s) can supply information on times when they are available to show properties and in what geographic area.

A decision is made by either or both whether to approve each showing agent within the selling agent's network of showing agents. If a showing agent is approved, they are added to the network. Once each showing agent is added to the selling agent's network, of showing agents, and the software can set up each showing agent with an account within the network,

In a preferred embodiment, the communication system is likely activated when a potential buyer sends a request to be shown a property. When a buyer request to be shown a property is received, the selling agent can send out the request to show the property.

The showing agent(s) selected by the selling agent and/or the system for notification receive and process the request. When each respective showing agent receives a request, they can respond with interest, a decline, or not respond to the request, which will typically act as a declining of the request. The selling agent or system receive and process acceptance(s) from the showing agents. Then a showing agent is selected to respond to this buyer request.

Once a showing agent is selected, the Selling agent, via the selling agent's device, or the system, typically via the central server notifies the buyer via the buyer's device that a showing has been arranged for them. Typically, the notification will provide pre-selected information about the showing agent, such as name and contact information. For an added layer of safety, and simply to avoid confusion, a picture of the showing agent may also be included in the notification.

If GPS technology is incorporated into the system, then the selling agent can receive, or access, real-time information on the location of the showing agent in relation to the property. In this manner, selling agent and buyer can receive real-time information about the seller's location and ETA to the property.

The showing agent and buyer can meet at the agreed time and location, and the showing agent can show the buyer the property. The system can be pre-programmed to send the showing agent necessary information about the property for showing, and the selling agent can be contacted with any further questions by the buyer.

After the property is shown, the showing agent can notify the selling agent the showing took place, or in an embodiment, the showing agent can pull up the system and file a brief report of the showing. In addition, the system can be programmed to seek buyer feedback on the showing agent, or the selling agent may obtain such feedback and enter it into the system. The selling agent can use this feedback to hone the network to the best available showing agents.

After the selling agent is aware the showing took place, the selling agent can then send an agreed-upon payment to the showing agent.

This system herein offers advantages and benefits to a number of parties, saving the selling agent the inefficiency of wandering about a large area to show properties, providing more conveniently arranged showings for buyers, and providing a convenient source of extra income nearby for showing agents.

### BRIEF DESCRIPTION OF THE DRAWINGS

FIG. 1 is a schematic diagram of a preferred embodiment of the invention.

FIG. 2 is a schematic diagram depicting a number of steps of a portion of one embodiment.

FIG. 3 is a schematic diagram depicting a number of steps of a portion of one embodiment.

### DETAILED DESCRIPTION OF PREFERRED EMBODIMENTS

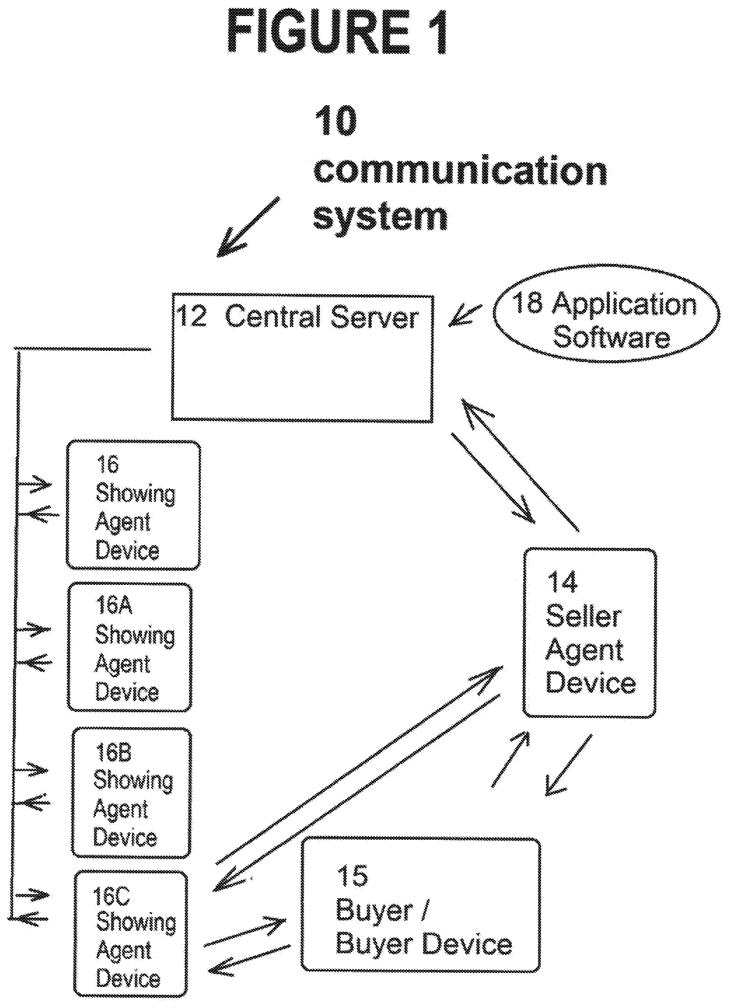

Disclosed herein is a real estate services communication system and method for improving the efficiency of real estate home showings. Turning to FIG. 1, the real estate communication system 10 is typically comprised of at least a central server 12, at least one seller agent communication device 14, at least one showing agent(s) devices (represented herein as 16, 16a, 16b, 16c) and application software 18.

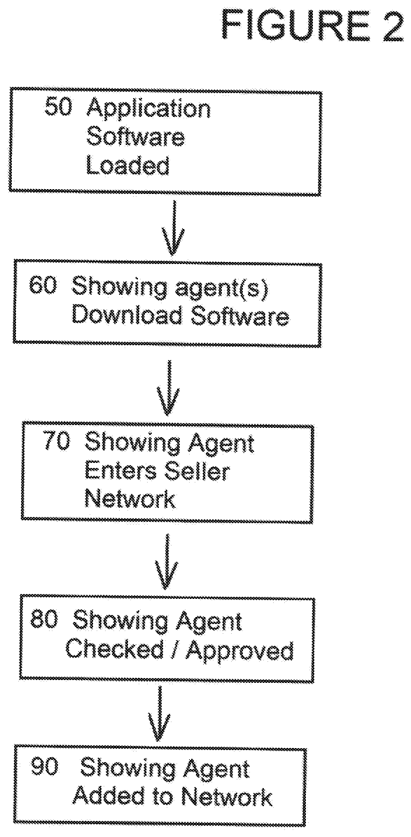

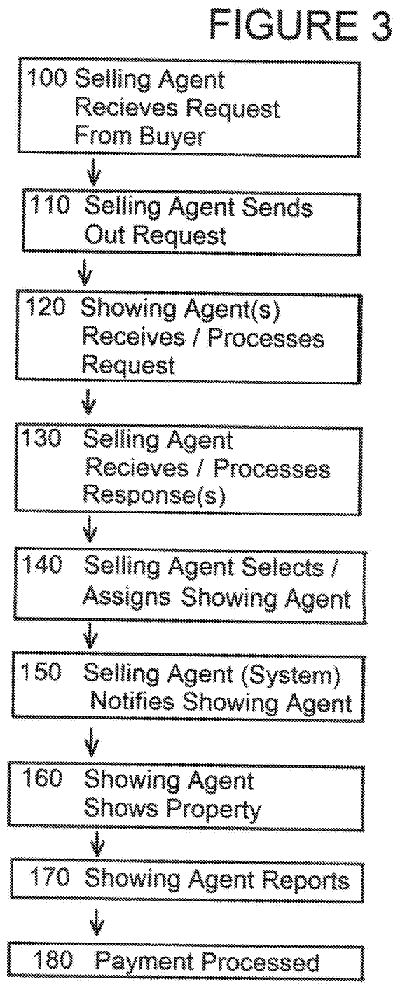

Generally, the system has a set-up and networking phase, and an operational phase. A preferred embodiment of the set-up and networking phase is shown in FIG. 2, and a preferred embodiment of the operational phase is shown in FIG. 3.

Turning to FIGS. 1-2, pre-created application software 18 for operating the system 10 is loaded 60 into a central server 12. The central server 12 can be any type device in the art capable of operating the software and operating the system described herein. This can be, but is not limited to, one or more PCs, laptops, tablets, smartphones, servers, or other electronic computing device or combination thereof. The central server 12 may be operated by the selling agent, or be hosted by another party with such device(s) such as a website hosting service.

Application software 18 capable of operating with that on the central server 12 is further loaded into at least one selling agent's communication device 14. This can be any device capable of communication and operating application software, such as, for example, a PC, tablet, laptop, or smartphone. In a preferred embodiment herein, the seller device 14 is a smartphone.

In another embodiment, the application software 18 is loaded into a single device, which may combine the functions of, and operate as, both selling agent communication device 14 and central server 12.

Next, one or more showing agents using suitable electronic devices (represented herein as 16, 16a, 16b, 16c) interested in receiving showing opportunities can obtain application software 18, designed for working with that of the central server 18, by downloading it 60 onto their respective devices 16, 16a, 16b, 16c. The showing agent can load the software into any suitable device, such as, for example, a smartphone, laptop, PC or tablet. In this embodiment, the showing agent communication device 16, 16a, 16b, 16c is also a smartphone.

The application software 18 can be loaded onto the showing agent communication devices 16, 16a, 16b, 16c by any suitable method in the art. For example, the selling agent may obtain the software 18 from an “App store” site on the smartphone, from a website, or receive software directly from the selling agent communication device 14.

Any devices using the application software 18, including the selling agent communication device 14, showing agent communication device(s) 16, 16a, 16b, 16c, or possibly a buyer communication device 15 will include an interface for using the software 18. The interface may have designed variation and arrangement, depending upon factors such as the party using the software and the purpose and function of the software for a given party.

Next, the respective showing agent(s) enter the selling agent's network of showing agents 70. This process can be determined by the selling agent. In one embodiment, the showing agent(s) is required to provide suitable identification and proof of being an agent in good standing, such as a real estate license number and other personal identifying information, such as name, age, and address. Other information can be requested to be entered into the showing agent communication device(s) 16, 16a, 16b, 16c, as appropriate.

Further, the showing agent(s) may be asked to provide information regarding paying the showing agent for services by any suitable method. For example, the showing agent(s) may be asked to provide banking information for direct transfer, an address for mailing a check, information to an online pay account such as paypal, patreon, subscribestar, or other information. This information is transmitted from the showing agent(s) device(s) 16, 16a, 16b, 16c to the central server 12 and/or to the selling agent's device 14, or combined function device. In another embodiment, the showing agent(s) devices 16, 16a, 16b, 16c include Global Positioning Satellite (GPS) location technology, as many devices such as tablets and smartphones do. The system 10 can be programmed to access GPS information on the showing agent(s) device(s) 16, 16a, 16b, 16c, automatically or with showing agent('s) agreement.

Next, the showing agent(a) applicant is evaluated and either accepted or not accepted into the network 80. Here, the software 18 can be programmed to run and confirm a check of the information provided by a potential showing agent. This can include confirmation of license numbers, confirmation of address, or evaluation of other information. In one embodiment, an important safety feature can be added, wherein a criminal background check, credit check, or both are run on an applicant showing agent.

These, particularly the criminal background check, can be an important safety feature, particularly in a business like real estate, where parties are often meeting clients or other agents alone, at uninhabited locations.

Further, potential showing agent(s) can supply information on times when they are available to show properties and in what geographic area.

The showing agent information can be evaluated by the software, by the seller, or a combination, based on background of the showing agent(s), the selling agent's needs, or other factors. A decision is made by either or both whether to approve each showing agent within the selling agent's network of showing agents. If a showing agent is approved 80, they are added to the network 90. Once each showing agent is added to the selling agent's network, of showing agents, the software 18 can set up each showing agent with an account within the network, give each showing agent login information to access the network and other appropriate steps or information to assist each added showing agent to be operational within the network.

Turning to FIGS. 1 and 3, an embodiment of the system is shown in operation. The communication system 10 is most likely activated when a potential buyer sends a request, likely from a buyer communication device of their own 15, such as a smartphone, computer, laptop, or other suitable device in the art, to be shown a property 100. The buyer can make the request by any suitable means, depending on selling agent and buyer preferences. The buyer may call or text the selling agent, or the buyer may enter the request, including preferred time and address, into a website. Further, the buyer may be given system application software 18. via the buyer device 15, to upload directly onto the buyer communication device 15.

When a buyer request to be shown a property is received, the selling agent can send out the request to show the property 110. The system can be programmed to have a setting wherein the seller can decide whether to send the request over the entire network or to certain showing agents, or one showing agent. The system can also take showing agent geographic areas and available times into account when determining which showing agent(s) to notify of the buyer request.

The showing agent(s) selected by the selling agent and/or the system 10 for notification receive and process the request. 120 When each respective showing agent receives a request, they can respond with interest, a decline, or not respond to the request, which will typically act as a declining of the request. The selling agent or system 10 receive and process acceptance(s) from the showing agents 130. Then a showing agent is selected 140 to respond to this buyer request. The system 10 or selling agent can then notify one showing agent at a time until there is an acceptance, accept the first “accept” from a showing agent, or use another suitable method to select an interested showing agent for the buyer request.

Once a showing agent is selected 140, the Selling agent, via the selling agent's device 14, or the system, typically via the central server 12 notifies the buyer via the buyer's device 15 that a showing has been arranged for them 150. Typically, the notification will provide pre-selected information about the showing agent, such as name and contact information. For an added layer of safety, and simply to avoid confusion, a picture of the showing agent may also be included in the notification.

If GPS technology is incorporated into the system 10, then the selling agent can receive, or access, real-time information on the location of the showing agent in relation to the property. This information can be forwarded to the buyer by selling agent, or if the buyer communication device 15 is included in the system 10, forwarded by the system 10 itself. In this manner, selling agent and buyer can receive real-time information about the seller's location and ETA to the property.

In another embodiment, if system application software 18 is downloaded onto a buyer communication device 15, this can include access to GPS technology on buyer's device 15 for the selling agent, showing agent, or both. Accordingly, the selling agent and/or showing agent can likewise be aware of buyer's location and ETA relative to the property.

The showing agent and buyer will meet at the agreed time and location, and the showing agent will show the buyer the property 160. The system 10 can be pre-programmed to send the showing agent necessary information about the property for showing, and the selling agent can be contacted with any further questions by the buyer.

After the property is shown 160, the showing agent may simply notify the selling agent the showing took place, or as in this embodiment, the showing agent can pull up the system and file a brief report of the showing 170. This report can help the selling agent when discussing the property with the buyer. The report can include information such as how the showing went overall, questions or concerns buyer had, buyer's perceived interest in the shown property, and concerns about the property itself. In addition, the system 10 can, depending upon buyer participation, be programmed to seek buyer feedback on the showing agent, or the selling agent may obtain such feedback and enter it into the system. The selling agent can use this feedback to hone the network to the best available showing agents.

After the selling agent is aware the showing took place, the selling agent can then send an agreed-upon payment to the showing agent 180. This can be done via conventional means, or through the system 10 using the information pre-suppled by the showing agent for payment, such as, e.g., direct electronic funds transfer.

This system 10 offers advantages and benefits to a number of parties, such as buyers, sellers, realtors, brokers, and possibly members of the public not represented by an agent. For a selling agent, this communication system 10 can create a well-vetted database of licensed home showers who can quickly show a property to a potential buyer. This saves the selling agent the inefficiency of wandering about a large area to show properties, taking away from activities that could more productively sell properties for the selling agent's clients.

Further, this system can save the seller and selling agent from losing potential buyers in a market where time is of the essence. Additionally, the selling agent is not forced to do most of the work to sell a home only to have to relinquish excessive portions of commission.

For a buyer, home showings are more conveniently arranged, with fewer delays in seeing wanted properties. This can help a buyer make the most of limited property viewing time.

It is also advantageous to showing agents. For agents who would prefer to work in a preferred area, or in a preferred time window, or not have to deal with the stresses and time of complete responsibility over selling a property, or any combination of these, this system can be an ideal source of income. Work is referred to such an agent, the agent shows properties in a limited area, time period or both, and is quickly compensated for that work.

### EXAMPLE

Mary is a selling agent with a number of properties to sell and limited time. Mary works in Vienna, Va. but has a number of properties listed in the Northern Virginia area. Rhoda, a potential buyer, sends Mary a request to see a property at 3 pm in Alexandria, Va. Between the distance and traffic, Mary will have to spend at least an hour simply driving to this showing. She will also show up early, wasting more time, or risk showing up late, antagonizing the buyer and possibly ruining the sale. Then she will be trapped in rush hour traffic, after the showing, to return to her office. This is a wasteful use of her time.

Instead, Mary turns to the system, bringing up the interface on her smart phone. She sends out a request or “ping” for a showing, including the place and time. The system, in this case, is customized to send the request only to potential showing agents within a specified limited area near the property.

A number of agents interested in showing properties for payment have signed onto Mary's network. To get into the network, they each had to provide identifying information proving that they are screened and qualified agents. The system then ran a criminal background check on each agent, so Mary can send each agent out with increased safety. In addition, the system may be programmed to run similar checks on identified buyers.

Several agents in the Alexandria area receive the ping notification. One Ted, declines because he is not interested at that time. Another, Murray, does not reply, which is treated as a “decline.” Lou is nearby and working from home. The time and place are near his home, and he's interested, so he accepts. Lou may be the only “accept” or the system may select him. Either way, he is notified he has been selected for the showing. The information about Lou is relayed to Rhoda, the buyer, either by the system or indirectly by Mary. Lou and Rhoda are both aware they are to meet at the property at 3 pm. Lou shows Rhoda the property.

After the showing, Lou can fill out and send a brief report of the showing so Mary knows what happened. In addition, Rhoda can provide feedback about Lou for Mary to evaluate, to improve her showing network. Upon being aware the showing took place Mary sends Lou payment with information he provided on how to do so. Here, Mary does so through Zelle™ direct funds transfer. Lou quickly sees he has been paid.

Because of this system, everybody benefited. Rhoda got to see the property at the time she wanted, using a nearby agent. Mary saved the time of coming out to Alexandria for this one showing and is still on track to be paid for the work she is providing in selling the property. Lou, for his part, has been paid a good amount of money for an hour or two of work nearby. This provides a good income to Lou, without having to deal with the responsibility of selling the property or further representing the buyer or seller himself.

Disclosed herein is a hardware-based communication system for effectively communicating and coordinating needed showings of properties among selling agents and showing agents, facilitating interactions among them, increasing operational efficiency, reducing costs, and improving the experience for potential property buyers.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A method of showing properties, comprising the steps of:
providing a real estate services communication system comprised of:
either at least one central server and at least at least one seller agent communication device, or only the at least one seller agent communication device,
and at least one showing agent communication device,
loading application software capable of operating the system into the central server, at least one seller device, or both,
selecting at least one showing agent to show at least one property,
either providing access to the application software, or loading the application software, to at least one showing agent communication device
sending a request from a buyer to be shown one or more properties from the seller device or central server to either a network of showing agents, a selected number of showing agents, or a single selected showing agent,
selecting a showing agent to show the buyer the at least one property and
notifying the showing agent of their selection.

2. A method of showing properties according to claim 1, wherein the at least one showing agent communication device is that of a showing agent, and further comprising the step of selecting and creating a network comprised of at least one showing agent.

3. A method of showing properties according to claim 2, wherein the selecting and creating the network of showing agents is further comprised of the steps of obtaining information about the at least one potential showing agent, evaluating the information, and either accepting or not accepting each potential showing agent into the network of showing agents.

4. A method of showing properties according to claim 3, comprising the further step of, if the potential showing agent is accepted into the network, providing the selling agent's device the capability to operate within the network and communicate with the seller's communication device within the network.

5. A method of showing properties according to claim 3, comprising the further step of:
pre-programming the communication system to include, for each selected showing agent, preferred geographic area, preferred times to show, or both.

6. A method of showing properties according to claim 2, wherein the selecting and creating the network of showing agents is further comprised of the step of
checking information provided by each potential showing agent.

7. A method of showing properties according to claim 2, wherein the selecting and creating the network of showing agents is further comprised of the steps of
running a criminal background check of each potential showing agent, running a credit check of each potential showing agent, or both.

8. A method of showing properties according to claim 2, wherein the selecting and creating the network of showing agents is further comprised of the steps of
obtaining time periods and geographic area in which each potential showing agent is available to show properties.

9. A method of showing properties according to claim 1, comprising the further step of providing a method of paying the showing agent from either the central server or the seller communication device

10. A method of showing properties according to claim 1, comprising the further step of loading the application software onto at least one buyer communication device.

11. A method of showing properties according to claim 1, wherein the selecting a showing agent to show the buyer the at least one property and notification steps are further comprised of the steps of
prioritizing the showing agents, and either:
Continuing selecting and informing showing agents of the buyer request until at least one acceptance is received from at least one showing agent,
selecting a showing agent from the at least one accepting showing agent(s), and notifying the selected showing agent
or,
informing prioritized showing agents one at a time until a showing agent accepts, and notifying that showing agent of their selection.

12. A method of showing properties according to claim 1, further comprising the steps of:
notifying the buyer, via a buyer communication device, that a j=showing has been arranged and
supplying the buyer with at least one piece of information about the selected showing agent.

13. A method of showing properties according to claim 1, further comprising the step of:
sending the selected showing agent at least one piece of information about the property to be shown.

14. A method of showing properties according to claim 1, further comprising the step of:
completing and sending a notification of the showing, a brief report of the showing, or both from the showing agent communication device to the selling agent communication device or central server.

15. A method of showing properties according to claim 1, further comprising the step of:
providing buyer feedback on the showing agent into the buyer communication device to the central server or seller communication device.

16. A method of showing properties according to claim 1, further comprising the step of:
sending payment electronically from the central server or selling agent communication device to the showing agent.

17. A method of showing properties according to claim 1,
wherein at least one central server is provided, and the at least one central server is at least one PC, at least one laptop, at least one tablet, at least one smartphone, at least one server, or a combination thereof.

18. A method of showing properties according to claim 1,
wherein the selling agent's communication device, and the showing agent communication device, is a smartphone, PC, tablet, or laptop, or smartphone, or combination thereof.

19. A method of showing properties according to claim 1,
wherein the application software is loaded onto the at least one showing agent communication device from an “App store” site, from a website, or from the selling agent communication device, or combination of these.

20. A method of showing properties according to claim 1,
comprising the further step of providing a buyer communication device, and
wherein the communication system is capable of accessing and transferring Global Positioning Satellite information from the at least one showing agent communication device to at least one other communication device, from the buyer communication device, to at least one other communication device, or both.
